(19) United States
(12) Patent Application Publication
(10) Pub. No.: US 2006/0060664 A1
(43) Pub. Date: Mar. 23, 2006

(54) Ice dam removal system

(75) Inventors: John R. Valiton, Maple Grove, MN (US); Scott B. Rethwill, Blaine, MN (US)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: IDRS, Inc., Minneapolis, MN (US)

(21) Appl. No.: 11/224,324

(22) Filed: Sep. 12, 2005

Related U.S. Application Data
(63) Continuation-in-part of application No. 10/937,994, filed on Sep. 10, 2004.

(51) Int. Cl. B05B 9/00

(52) U.S. Cl. 239/142

(57) ABSTRACT

An ice dam removal system comprises a porous container and a deicing component disposed within the container.

### CROSS REFERENCE TO RELATED APPLICATIONS

This application is a continuation-in-part application of Application Ser. No. 10/937,994 filed on Jul. Sep. 10, 2004, the entire content of which is incorporated by reference in this application.

### BACKGROUND OF THE INVENTION

The present invention relates to the removal of ice dams. More specifically, the present invention relates to an ice dam removal system comprising a deicing component encased within the porous container. The deicing component comprises deicing agent(s) and corrosion-inhibiting agent(s) that form a brine solution when placed in contact with ice or water that is effective to melt and/or prevent ice formation on a roof. The present invention further comprises a method of forming the ice dam removal system and a method of using the ice dam removal system.

Ice dams tend to build up on the overhang or eaves of a building adjacent the areas of roof drains and gutters. This is so because the eaves are generally less insulated and situated at the lower edge of the roofline where less heat is stored. Consequently, as heat rises within the building, snow and/or ice present on the upper portion of the roof tends to melt and run down the roof to the eaves where it re-freezes, thus causing the formation of an ice build-up. As this process continues, ice dams form and the water running down the roof begins to pool and back up underneath the roof shingles, where it then enters the building causing significant damage to the inner wall structures. As ice continues to collect and block the drains, more water collects and more ice forms, causing the damage to multiply.

Currently there are only a few known options available to remove ice dams, most of which have either met with little or no success, or are too costly to implement to be practical for the average homeowner. For instance, manually hammering or chipping the ice dams away has been previously contemplated. Also, removal methods utilizing electric cables, steam blasting, and torching have also been employed in the past. Not only are such options time consuming and expensive to implement, none are recommended by roofing authorities. As noted by the Candia Asphalt Shingles Roofing Manufactures Association, all such methods may result in significant permanent damage to the roof shingles and/or involve numerous safety hazards (electrical shock, fire, etc.).

In addition, previous attempts have included the use of salt (NaCl) brine formed when rock (granular) salt is mixed with water. Unfortunately, salt brine is very corrosive to metal gutters, drain pies and other metal structure with which it comes in contact. Furthermore, significant damage to nearby grass, trees, shrubbery and all other plant life can occur when salt is used as a deicing agent. Unless additional and expensive care is taken to control the distribution of salt brine, substantial damage will result to the lawns, trees and shrubbery adjacent its use, since almost all drains discharge at their lesser end, and the salty water reaches the areas where such vegetation is normally located.

Additionally, salt (NaCl) is solid in its natural state and therefore, must absorb heat from the environment upon transforming to a brine solution. As a result, salt is a relatively slow acting agent and generally unreliable in cases of emergency. Brine solution generated from common rock salt will also not melt ice in temperatures below about 15° to 20° F. Therefore, application of rock salt to eliminate ice dams in temperatures below 15° F to 20° F., is generally considered to be ineffective.

### SUMMARY OF THE INVENTION

The present invention includes an ice dam removal system comprising a porous container and a deicing component disposed within the container.

### BRIEF DESCRIPTION OF THE DRAWINGS

FIG. 1 is a perspective view of an ice dam removal system comprising a deicing composition encased in a porous fabric container in accordance with the invention:

FIG. 2 is a side elevational view showing the manner in which the porous container of the ice dam removal system may be loaded with the deicing composition.

FIG. 3 is an exploded perspective view showing the manner in which the porous fabric container carrying the deicing composition may be inserted in an outer solid polymeric bag for storage and transportation.

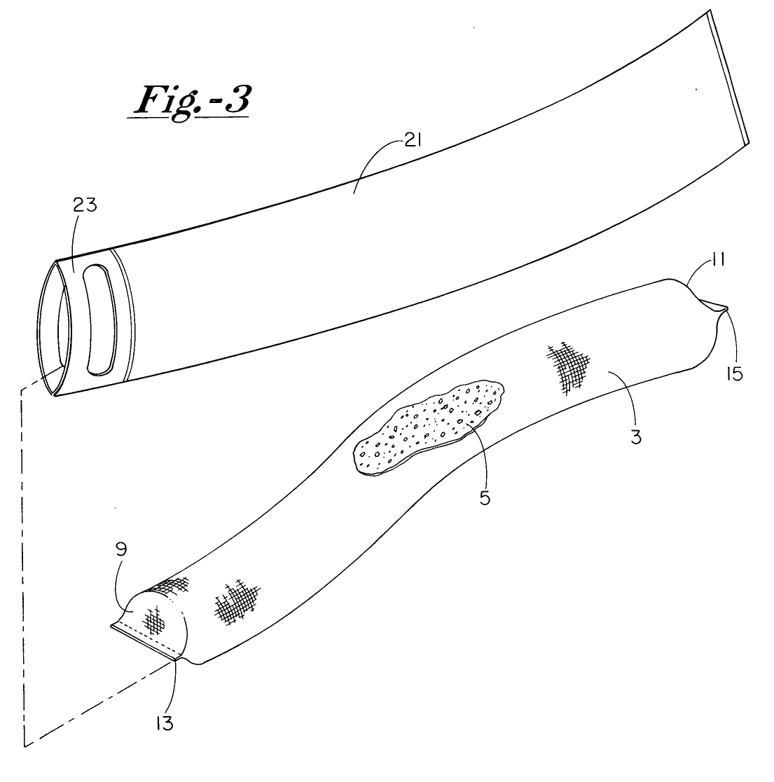

FIG. 4 is a partial side elevational view of a roof portion of a building, showing the manner in which the ice dam removal system may be used in a typical deicing application.

### DETAILED DESCRIPTION

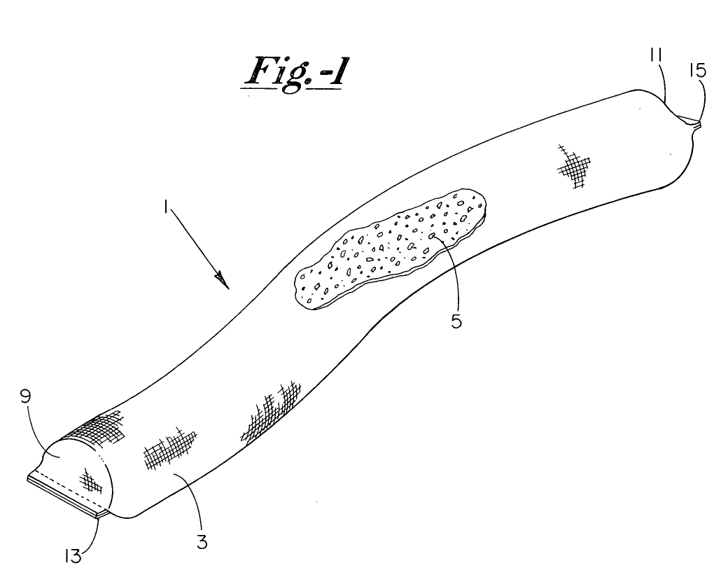

An ice dam removal system of the present invention is generally depicted at 1 in FIG. 1. The ice dam removal system 1 comprises a porous container 3 defining a hollow interior (not shown) and a deicing component 5. The deicing component 5 is disposed in the hollow interior of the porous container 3. The ice dam removal system 1 can be used to eliminate ice dams on a roof at a temperature down to at least about −15° F., with a substantial reduction in corrosive damage when compared to corrosive effects from application of salt (NaCl) or salt (NaCl) brine solutions.

Furthermore, the porous container 3 may be in any shape or form, such as substantially spherical, conical, tubular, cylindrical, pyramidal, prismatic, cubical, or other types of polyhedral forms so long as the porous container 3 defines an interior in which the deicing component 5 may be located. It should be understood that although specific three dimensional forms are mentioned herein that the container being made of a fabric which is flexible and filled with a granular substance that may flow or move within the container may not take exactly the forms being mentioned herein. As an example, the porous container 3 is generally in the form of an elongated tubular structure as best depicted in FIG. 1.

Additionally, the porous container 3 can be of any size that is effective to (a) hold the deicing component 5, (b) permit water to flow through freely, (c) maximize formation of a deicing liquid mixture (not shown), and (d) maximize the ice melting characteristics. As an example, when the porous container 3 is in the form of an elongated tubular structure, a length of the porous container 3 ranges from about 96.8 centimeters (cm) to about 102.8 cm, a width that ranges from about 19.1 cm to about 21.1 cm and a thickness that ranges from about 7.2 cm to about 7.8 cm. In another example, a length of the porous container 3 ranges from about 96.8 centimeters (cm) to about 102.8 cm, a width that ranges from about 15.5 cm to about 16.5 cm and a thickness that ranges from about 7.2 cm to about 7.8 cm.

In general, the porous container 3 can be derived from any porous material so long as the porous material is capable of allowing water to freely flow through the material. Accordingly, the porous container 3 is derived from any porous material that can be characterized as “water permeable” and water absorbing”. As used herein, the term “water-permeable” refers to an ability of a material to allow water to pass through, flow through, be transported or penetrated by water. The term “water-absorbing” refers to the process by which a material takes up or takes in water molecules.

The porous container 3 is made of a woven material, non-woven material, or any combination of woven and non-woven material. As an example, the porous material is constructed of a flexible cotton or polymeric woven fabric which is designed such that the interstices defined by the interwoven strands or yarn are sufficiently small to retain the granular deicing component 5 therein, yet sufficiently sized to accommodate and allow water to flow freely therethrough.

In another example, the fabric used as part of the porous container is composed of high-tenacity monofilament polypropylene yarns, which are substantially inert to biological degradation and resist naturally encountered chemicals, alkalines, and acids. Such polypropylene yarns are woven into a stable network such that the yarns retain their relative position and structural integrity. One such material found suitable for meeting these general requirements is the Miraf1® Filterweave® fabric manufactured by TC Mirafi Engineering Services, Inc., 365 South Holland Drive, Pendergrass, Ga., 30567. The Mirafi® Filterweave® 402 fabric is one example of a fabric that will suitably accommodate the above desired characteristics.

The material of the porous container may also be characterized in terms of a liquid flow rate therethrough. As an example, the flow rate of the material used to prepare the porous container can range from about 18 to about 155 gallon per min per square foot (gal/min/ft²) as measured by ASTM D4491. In a second example, the flow rate of the material is at least about 70 gal/min/ft2. In a third, the flow rate ranges from about 100-150 gal/min/ft².

The porous container may also be characterized in terms of the porosity or average pore size of the material. As an example, the material has an opening size that ranges from about 30 to about 100 as measured on the U.S. Sieve Mesh system. The porous container can also be characterized in terms of permeability to water. As an example, the permeability can range from about 0.01 to about 0.23 cm per sec, as measured using ASTM D4491 measurement protocol for fabrics.

To form the porous container 3 into the desired tubular configuration illustrated in FIG. 1, it is contemplated that a generally rectangular sheet of the above material be rolled in such manner that the opposite elongated sides of the fabric may be stitched or sewn together to form an internal or external seam (not shown) extending the length thereof. In order to complete the construction of container 3 with a closed interior for carrying the deicing component mixture 5, each of the opposite ends 9 and 11 of container 3 are also stitched or sewn along lines 13 and 15, respectfully.

The deicing component 5 that is used in accordance with the present invention generally comprises one or more deicing agent(s) and one or more corrosion-inhibiting agent(s). Furthermore, the deicing component 5 may be generally encased within the porous container 3 as a liquid, pellet, resin, gel, solid or in granular form. The form and amount of the deicing component 5 that is included preferably permits the deicing component 5 (a) to remain stable prior to the absorption of water, (b) to melt ice at temperatures down to at least about −15° F., (c) to minimize or eliminate most, if not all related corrosion of surfaces or structures in contact with the ice dam removal system, and (d) to create a sustained deicing effect at temperatures down to at least about −15° F.

Furthermore, those of ordinary skill in the art will recognize that the amount of the deicing component 5 may vary, depending upon the type of material used to form the porous container 3, the types of deicing agent(s) selected, any other additives that are used as part of the deicing component 5, the outdoor temperature, the surface material on which the ice dam removal system 1 is placed, the particle size of the deicing agent(s), or the desired melting time period.

The deicing agent(s) may be supplied as individual deicing agent(s), or supplied in various prepared mixtures of two or more deicing agents that are subsequently included as part of the deicing component 5. Furthermore, the deicing agent(s) may comprise relatively aggressive deicing agent(s), slow acting deicing agent(s), or any combination of relatively aggressive and slow-acting deicing agents. As used herein, the term “relatively aggressive deicing agent” refers to a deicing agent or substance that rapidly absorbs moisture and emits heat upon contacting ice or liquid water or being dissolved. Similarly, the term “slow-acting deicing agent” refers to deicing agents that absorb heat from their environment when absorbing water or being dissolved. In general, relatively aggressive deicing agents work more rapidly than slow-acting deicing agents.

Some non-exhaustive examples of relatively aggressive deicing agent(s) comprise magnesium chloride, calcium chloride and any combinations thereof. Some non-exhaustive examples of slow-acting deicing agent(s) comprise potassium chloride, sodium chloride, or any combinations thereof.

The deicing agent(s) may be supplied as a liquid, pellet, resin, gel, solid or in granular form. The form and amount of the deicing agent(s) that are included as part of the deicing component 5 generally permit (a) homogeneous application and/or blending of the deicing agent(s) with the corrosion-inhibiting agent(s), (b) ice melting effectiveness at temperatures down to at least −25° F., and (c) maximum heat generating ability during transformation of the deicing component 5 into a deicing liquid mixture.

It is further noted that calcium chloride and magnesium chloride are liquids in their natural state, therefore, these deicing agent(s) will normally return to a liquid state when possible. Therefore, when granular forms of these deicing agent(s) are included as part of the deicing component 5, the deicing agent(s) rapidly absorb moisture and emit heat upon contacting ice, snow or water. As a result, a strong deicing brine solution is formed that is capable of aggressively attacking and melting the ice dam Calcium chloride and magnesium chloride are also relatively aggressive deicing agent(s) in that they effectively melt ice in temperatures well below that of common rock salt (down to about −25° F., and 5° F., respectively).

Those of ordinary skill in the art may also vary the amount of deicing agents based upon desired ice melting and corrosion inhibiting characteristics of the ice dam removal system 1. Consequently, the deicing agent(s) may be any amount that provides the necessary ice melting capabilities. As an example, the deicing agents of the deicing component 5 is sodium chloride or a mixture of at least about 70 weight percent sodium chloride and less than about 30 weight percent magnesium chloride, potassium chloride, and/or calcium chloride. In another example, the deicing component 5 comprises calcium chloride.

The corrosion-inhibiting agent(s) may be supplied as individual corrosion-inhibiting agent(s), or supplied in various prepared mixtures of two or more corrosion-inhibiting agent(s) that are subsequently included as part of the deicing component 5. By “corrosion-inhibiting agent” is meant a substance which when added in a small concentration to an environment effectively reduces the corrosion rate of a metal exposed to that environment.

Some non-exhaustive examples of corrosion inhibiting agent(s) comprise chromate, nitrate nitrite, zinc sulfate, water-soluble rare earth salts, water-soluble organic acids salts, or combinations thereof. Water-soluble rare earth salts comprise at least one rare earth element in combination with at least one anion. As an example, rare earth elements with atomic number of approximately 57 to 60, such as lanthanum, cerium, praseodymium, and neodymium are suitable for use when practicing the present invention.

In another example, only lanthanum is the rare earth element that is used to form the corrosion inhibitor agent when practicing the present invention. Examples of suitable anions of the water-soluble rare earth salts comprise chloride, nitrate, acetate, or sulfate.

Some non-exhaustive examples of suitable water-soluble rare earth salts comprise lanthanum chloride, cerium chloride, praseodymium chloride, neodymium chloride, lanthanum nitrate, cerium nitrate, praseodymium nitrate, neodymium nitrate, lanthanum acetate, cerium acetate, praseodymium acetate, neodymium acetate, lanthanum sulfate, cerium sulfate, praseodymium sulfate, and neodymium sulfate. As an example, water-soluble rare earth elements comprise lanthanum chloride, lanthanum nitrate, lanthanum acetate, and lanthanum sulfate when practicing the present invention.

Water-soluble rare earth salts may be supplied as individual rare earth salts, or two or more mixtures of water-soluble rare earth salts. As an example, water-soluble rare earth salts comprise at least two salts selected from the group consisting of lanthanum chloride, cerium chloride, praseodymium chloride, and neodymium chloride. In another example, water-soluble rare earth salts comprise about 58 to 68 weight percent lanthanum chloride, about 20 to 24 weight percent neodymium chloride, about 1 to 15 weight percent cerium chloride, and about 7 to 9 weight percent praseodymium chloride.

Water-soluble organic acid salts generally comprise at least one metal cation and at least one organic anion salt. Some non-exhaustive examples of suitable cations include alkali metal cations, such as sodium and potassium, alkaline earth metal cations, such as magnesium and calcium, transition metal cations, such as zinc, iron, and the like.

Some non-exhaustive examples of suitable water-soluble organic anion salts comprise gluconate salts, ascorbate salts, tartarate salts, succinate salts, saccharate salts, or any combination of the water soluble organic acid salts listed in U.S. Pat. No. 5,531,931 the entire content of which is incorporated herein by reference, and/or any combination thereof. As an example, water-soluble organic acid salts comprise sodium gluconate, potassium gluconate, magnesium gluconate, calcium gluconate, and zinc gluconate.

The water-soluble organic acid salt that is used to practice the present invention may be supplied as individual salts, or mixtures of two or more water-soluble organic acid salts. The water-soluble organic acid salt may be added directly as a salt or as a free acid that can be converted into a salt in situ with an appropriate base, such as magnesium, calcium, potassium, or sodium hydroxide or oxide.

When the corrosion inhibitor is added to deicing agent(s) in granular or pellet form, the deicing component 5 provides effective ice melting with significantly reduced corrosion effects. Furthermore, combining corrosion-inhibitor agent(s) may demonstrate a synergistic corrosion-inhibition effect. For example, when significantly lower total concentrations of water-soluble rare earth salts in combination with a water soluble organic acid salts are used, essentially the same degree of corrosion inhibition is observed when compared to individual higher concentrations of the two inhibitors that are not combined. The individual corrosion-inhibitor agent(s) are, however, still effective when used alone and can, if desired, be used in that manner.

In another example, the deicing component 5 of the present invention can contain a single corrosion-inhibitor agent comprising water-soluble rare earth salts and water-soluble organic acid salts or, a mixture of water-soluble rare earth salts and water-soluble organic acid salts.

When the deicer agent(s) are in granular or pellet form, the corrosion-inhibitor agent(s) should be evenly distributed throughout the deicer agent(s) to ensure that the entire deicing component 5 has the desired corrosion-inhibiting effect. Such an essentially homogenous distribution can be obtained using conventional particulate handling and mixing techniques.

When forming the deicing component 5, the deicing agent(s) are typically supplied in granular or pellet form and blended with each other, prior to mixing with the corrosion-inhibiting agent(s). As an example, deicing agent(s) in pellet form are blended with each other and then uniformly or substantially evenly coated with a liquid form of the corrosion-inhibiting agent(s).

For instance, when magnesium chloride is used as a deicing agent, magnesium chloride can be supplied as a liquid or as a pellet. When magnesium chloride is supplied as a liquid, magnesium chloride is combined with the corrosion-inhibiting agent before mixing with the other deicing agents. When magnesium chloride is supplied in pellet form, magnesium chloride is combined with the other deicing agents before mixing with the corrosion-inhibiting agent(s).

Generally, the deicing component 5 comprises at least about 90 weight percent deicing agents. In general, when using a single corrosion-inhibitor agent, the deicing component 5 will generally comprise, on a dry weight basis, about 94.0 to about 99.5 weight percent, and preferably about 95.0 to about 99.0 weight percent, deicing agent; and about 0.5 to about 6.0 weight percent, and preferably about 1.0 to about 5.0 weight percent, of a corrosion-inhibitor agent in the form of water-soluble rare earth salts and water-soluble organic acid salts.

For example, the deicing agent(s) comprise at least about 94 percent deicing agent(s) when zinc sulfate is the corrosion-inhibiting agent of the present invention. For example, when zinc sulfate in the form of a liquid is used in the present invention, an amount of about 5% zinc sulfate by weight of the deicing component 5 is applied to the deicing agent(s) in the form of a spray so as to substantially coat or encapsulate the granular deicing agent(s). In another example when a water-soluble rare earth salt is combined with a water soluble organic acid salt to form the corrosion-inhibiting agent, the deicing agent(s) are preferably at least about 96 percent deicing agent, on a dry weight basis.

When using a mixture of water-soluble rare earth and organic acid salts, the deicing component 5 will generally comprise, on a dry weight basis, about 90.0 to about 99.8 weight percent, preferably about 94.0 to about 99.6 weight percent, and more preferably about 96.0 to about 99.6 deicing agent; about 0.1 to about 5.0 weight percent, and preferably about 0.2 to about 3.0 weight percent, of the water-soluble rare earth salt; and about 0.1 to about 5.0 weight percent, and preferably about 0.2 to about 3.0 weight percent, of the water-soluble organic acid salt. In another example, the deicing component 5 will comprise, on a dry basis, about 98.4 to about 99.6 weight percent deicing agent(s), about 0.2 to about 0.8 weight percent water-soluble rare earth salt, and about 0.2 to about 0.8 weight percent water-soluble organic acid salt.

Furthermore, the deicing component 5 may optionally comprise conventional deicer additives including, for example, anti-caking agents, deicing rate accelerators, colorants, and the like. Preferably, the deicing component 5 of the present invention is phosphate free.

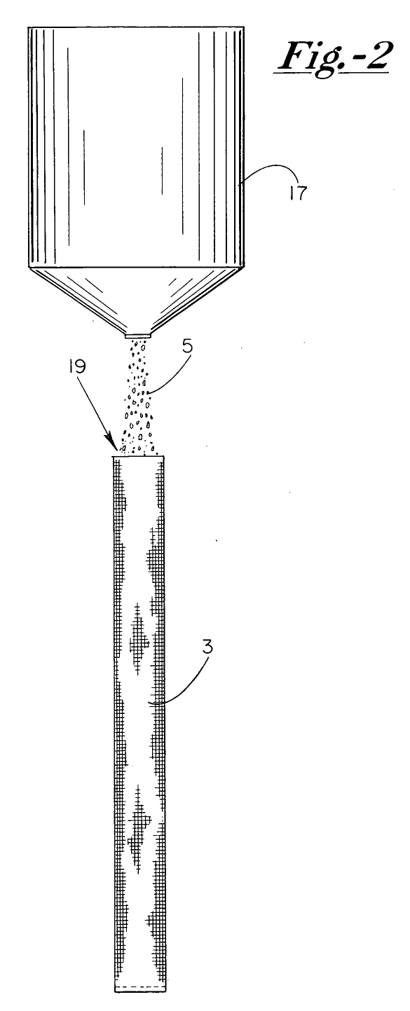

As illustrated best in FIG. 2, once any deicing agents or corrosion-inhibiting agents are sprayed on and allowed to dry, the resulting deicing component 5 may be loaded into a hopper 17, which may be utilized to automatically feed and load the desired amount of deicing component 5 into a plurality of porous containers 3 on a production scale basis. As seen in FIG. 2, notably, each porous container 3 is initially provided with an opening 19 at one end thereof which allows the granular deicing component 5 to be loaded into the interior thereof Once each container 3 is loaded with the desired amount of deicing component 5, the container is sealed shut through a secondary sewing or stitching operation to close the open end 19 thereof, as illustrated in FIG. 1.

Notably, in contrast to prior art devices, the negative environmental effects commonly associated with the use of sodium chloride are largely off-set by other deicing agent(s) contained in the above deicing mixture. For instance, with the exception of sodium chloride, each of the above deicing agents is commonly used to some extent in agricultural applications. Potassium chloride, in particular, is commonly used as a fertilizer for vegetation, and will therefore help to counter the potential for damage to the surrounding vegetation, such as grass, trees, and shrubs which may come in contact with the discharged brine solution. Also, the specific inclusion of zinc sulfate as a corrosion inhibiting agent will help counter the corrosive effects of the remaining deicing agents, particularly that of the sodium chloride.

By utilizing the above mixture of relatively aggressive deicing agents, in combination with the slower-acting deicing agents and corrosion-inhibitor agent(s), a deicing component 5 is formed that will effectively and aggressively melt ice in temperatures down to at least about −15° F. Upon absorbing moisture, the resulting deicing component 5 will first aggressively attack the ice with which it makes contact, creating a strong deicing liquid mixture composed of the above chemicals. The deicing liquid mixture will thereafter continue to melt the ice, thereby creating more water, and forming additional deicing liquid mixture. While the more aggressive deicing agents react quickly to absorb moisture and create more water, the slower acting deicing agents will also be absorbed by passing water and create a more sustained, long-lasting deicing effect.

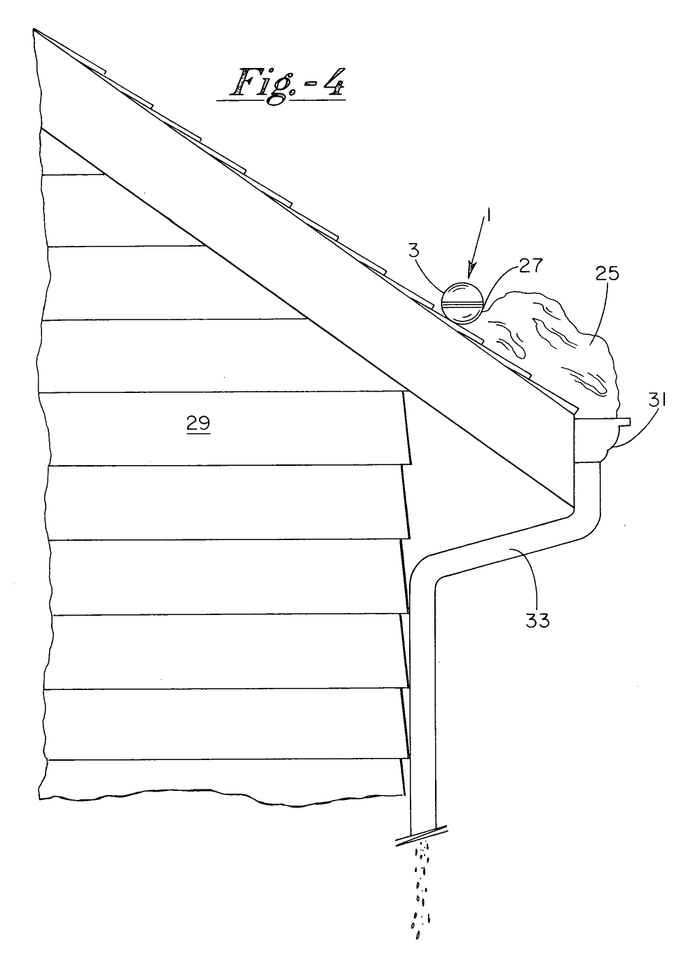

In use, as shown in FIG. 4, our improved ice dam removal system may be placed on any rooftop experiencing the formation of an ice dam 25 at a point immediately adjacent the upper edge 27 thereof. Although it is possible to externally secure container 3 in a position adjacent the ice dam 25, it is deemed preferable to allow the ice dam removal system 1 to physically abut 5 and rest against the ice dam, as illustrated in FIG. 4. In such case, the ice dam will effectively retain the container 3 in proper position adjacent the upper edge 27 thereof. As shown, the flexible woven material of container 3 and deicing mixture 5 therewithin will conform generally to the shape of the upper edge 27 of ice dam 25, as it rests thereagainst.

As heat rises within the building structure 29, the upper portions of the roof are warmed, consequently causing snow and/or ice thereon to melt and run downwardly toward the ice dam removal system. Due to the porous nature of the container 3, water running down the roof will enter the container and begin absorbing the granular deicing mixture 5 contained therewithin. Upon absorption of the deicing agents, a strong brine solution is created which comes in contact with the ice dam 25, thereby effectively depressing the freezing temperature of such ice and causing same to melt. Such brine solution will effectively create channels through the ice dam, causing further melting thereof and drainage into the gutter 31. Because the brine solution also contains an effective corrosive inhibitor, the potential damaging effects of the sodium chloride and/or other agents are minimized. As the solution and melted ice flow through and out the discharge end of drain pipe 33, any ill effects of the vegetation normally caused by the presence of sodium chloride are also minimized due to the added fertilization effects caused by the inclusion of potassium chloride.

With the ice dam removal system of the present invention, the formation of ice dams upon roofs may be effectively removed and prevented without causing damage to the shingles or creating safety hazards, as commonly associated with conventional manual techniques for removal of such ice dams. The ice dam removal system of the present invention provides a unique and inexpensive means for aggressively attacking and preventing ice formations upon roofs, and utilizes an aggressive yet less corrosive deicing chemical mixture that inhibits corrosion of metal 5 gutters and drains, and counters the negative environmental impact commonly associated with other conventional chemical deicing apparatus.

In another embodiment, the porous container can be shaped into an elongated tubular structure that defines two hollow interiors separated from each other by a centrally located barrier to form a two compartment porous container (not shown). This two compartment porous container may be used to keep any of the deicing agent(s) separate from each other or from any of the corrosion inhibiting agent(s) so that the (a) shelf life of the ice dam removal system is improved, (b) enhanced ice melting and corrosion inhibiting activity is attained by allowing the deicing agent(s) and corrosion inhibiting agent(s) to mix with each other to form the deicing liquid mixture only when required, and/or (c) allow the formation of novel deicing/corrosion-inhibiting agent(s).

For example, calcium magnesium acetate is a deicer that minimizes the degree of corrosion when used. CMA is prepared by the reaction of dolomitic lime and acetic acid. The present invention in the form of a two compartment porous container can comprise dolimitic lime in one compartment and granular acetic acid in another compartment that is only mixed when water flows into one or both compartments of the porous container to form CMA.

Although the present invention has been described with reference to preferred embodiments, workers skilled in the art will recognize that changes may be made in form and detail without departing from the spirit and scope of the invention.

What is claimed is:

1. An ice dam removal system comprising:
a porous container;
a deicing component disposed within the container, the deicing component comprising a deicing agent and a corrosion-inhibiting agent; and
wherein the container is adapted for water flowing therethrough wherein the water being mixed with the deicing component to form a deicing liquid mixture that is effective to melt ice.

2. The ice dam removal system of claim 1 wherein the deicing liquid mixture is effective to depress the freezing point of the ice.

3. The ice dam removal system of claim 1 wherein the deicing agents comprises calcium chloride, sodium chloride, magnesium chloride, potassium chloride or any combination of any of these.

4. The ice dam removal system of claim 1 wherein the corrosion-inhibiting agent comprises chromate, nitrate nitrite, zinc sulfate, water-soluble rare earth salts, water-soluble organic acids salts, or combinations thereof.

5. The ice dam removal system of claim 1 wherein the container absorbs water through any surface of the container.

6. An ice dam removal system comprising:
a deicing component comprising at least one deicing agent and zinc sulfate, a water-soluble rare earth salt, a water-soluble organic acid, or any combination of any of these; and
a porous container, wherein the deicing component is disposed within the container.

7. The ice dam removal system of claim 6 wherein the deicing component is capable of forming a deicing liquid mixture that is effective to melt ice at a temperature down to at least about −15° F.

8. The ice dam removal system of claim 7 wherein the deicing liquid mixture is effective to melt ice at a temperature down to at least about −25° F.

9. An ice dam removal system comprising:
a deicing component comprising aggressively melting deicing agent(s), slow-acting deicing agent(s) and at least one corrosion-inhibiting agent; and,
a water-permeable porous container defining a hollow interior, wherein the deicing component is disposed within the hollow interior.

10. The ice dam removal system of claim 9 wherein the container is capable of absorbing water from any surface of the container.

11. The ice dam removal system of claim 9 wherein the container comprises a material having a flow rate of about 18 to about 155 gallons per minute per square foot.

12. The ice dam removal system of claim 9 wherein the porosity of the container ranges from about 30 to about 100 US Sieve Mesh.

13. The ice dam removal system of claim 9 wherein the permeability ranges from about 0.01 to about 0.23 cm per sec.

14. The ice dam removal system of claim above wherein the container is derived from a woven material, a non-woven material, or any combination of woven and non-woven material.

15. The ice dam removal system of claim above wherein the container comprises a shape substantially in the form of a spherical, conical, tubular, cylindrical, pyramidal, prismatic, cubical, or any other type of polyhedral form.

16. The ice dam removal system of claim above wherein the container is an elongated tube comprising a thickness of about 7.2 to about 7.8 cm, a length of about 96.8 cm to about 102.8 cm and a width of about 15.5 cm to about 16.5 cm.

17. An ice dam removal system comprising:
a deicing component comprising aggressively melting deicing agent(s), slow-acting deicing agent(s) and at least one corrosion-inhibiting agent;
a water-permeable porous container defining a hollow interior, wherein the deicing component is disposed within the hollow interior; and,
wherein the ice dam removal system is effective to melt ice at temperatures down to at least about −25° F.

18. The ice dam removal system of claim 17 wherein the ice dam removal system is effective to melt ice at temperatures down to at least about −25° F.

19. The ice dam removal system of claim 17 wherein the ice dam removal system is effective to met ice at temperatures down to at least about −15° F.
